(19) United States
(12) Patent Application Publication
(10) Pub. No.: US 2021/0401005 A1
(43) Pub. Date: Dec. 30, 2021

(54) PREPARING METHOD OF NUTRITION-BALANCED DUMPLINGS BASED ON MORE THAN THIRTY KINDS OF FOOD INGREDIENTS

(71) Applicant: Hua YANG, Yichang City (CN)

(72) Inventor: Hua YANG, Yichang City (CN)

(21) Appl. No.: 17/030,530

(22) Filed: Sep. 24, 2020

(30) Foreign Application Priority Data
Jun. 24, 2020 (CN) 202010584110.2

(51) Int. Cl. A23L 7/109; A23P 20/25

(52) U.S. Cl. CPC A23L 7/11; A23P 20/25

(57) ABSTRACT

A preparing method of nutrition-balanced dumplings based on over thirty kinds of food ingredients includes steps of: S1, providing raw materials for a dumpling dough, a dumpling filling and a seasoning, preparing the dumpling dough, and proofing the prepared dumpling dough for 40-50 minutes; S2, preparing the dumpling filling during proofing the prepared dumpling dough by cutting a main food material, an auxiliary food material and an additive food material to 0.5 mm in lengths, adding the seasoning and stirring; S3, rolling the proofed dumpling dough for wrapping the dumpling filling to obtain dumplings, putting the dumplings into a pot with cold water and heating for cooking the dumplings with a period of 7-8 minutes; and S4, taking the dumplings out of the pot after the cooking for being eaten with a dipping sauce. The problem of lack of balanced nutritious food supply in the existing market is solved consequently.

### TECHNICAL FIELD

The invention relates to technical improvements in the catering industry, and more particularly to a preparing method of nutrition-balanced dumplings based on more than thirty kinds of food ingredients.

### DESCRIPTION OF RELATED ART

Dumplings are actually not only a kind of traditional Chinese food, but also one of common traditional foods of mankind, which have a history of more than 1,800 years in China.

In a traditional preparing process of dumplings, attention is paid to different tastes and individual preferences of people in different regions, but it is insufficient in the comprehensive and reasonable combination of nutrients.

When preparing dumplings, kinds of the food ingredients are unreasonably matched and proportions of various food ingredients are not controlled, resulting in some of them have a high nutrient content and some have a low nutrient content, which will adversely affect bodies of consumers. Current dumpling filling recipes on the market are very single in the variety and quantity of food ingredients (including seasonings), most of which are three to five kinds, and a few of which are more than ten kinds. Although the taste and texture have their own advantages, the nutrition is not comprehensive and balanced. A dumpling filling recipe associated with the invention pays attention to the function of dumplings as a carrier for a reasonable combination of multiple nutrients.

### SUMMARY

An objective of the invention is to solve a problem of lack of balanced nutritious food supply in the existing market, and thus provide a preparing method of nutrition-balanced dumplings based on more than thirty kinds of food ingredients.

In particular, a preparing method of nutrition-balanced dumplings based on more than thirty kinds of food ingredients including a dumpling dough, a dumpling filling, a seasoning and a dipping sauce is provided. The dumpling dough includes raw materials: 800-900 parts by mass of flour and 400-450 parts by mass of water. The dumpling filling includes raw materials: 250-310 parts by mass of a main food material, 250-310 parts by mass of an auxiliary food material, and 500-620 parts by mass of an additive food material. The preparing method includes following steps of:

S1, providing raw materials for the dumpling dough, the dumpling filling and the seasoning, preparing the dumpling dough, and proofing the prepared dumpling dough for 40-50 minutes;

S2, preparing the dumpling filling during proofing the prepared dumpling dough by cutting the main food material, the auxiliary food material and the additive food material to 0.5 mm in lengths, adding the seasoning and stirring;

S3, rolling the proofed dumpling dough for wrapping the dumpling filling to thereby obtain dumplings, putting the dumplings into a pot with cold water and then heating for cooking the dumplings with a period of 7-8 minutes; and

S4, taking the dumplings out of the pot after the cooking for being eaten with the dipping sauce.

In an embodiment, the flour and the water in the dumpling dough has a mass ratio of 2:1, and the main food material, the auxiliary food material and the additive food material in the dumpling filling has a mass ratio of 1:1:2.

In an embodiment, the main food material includes any one of Chinese cabbage, leek, pea sprout, and 9:1 refined meat.

In an embodiment, the auxiliary food material includes hen's egg, quail egg, tofu and yuba; and the hen's egg, the quail egg, the tofu and the yuba are prepared in equal parts by mass.

In an embodiment, the additive food material includes edible wolfberry leaf, Longkou vermicelli, spinach, celery, cordyceps flower, diced carrot, corn grain, segmented shallot, shredded green Chinese onion, shredded color pepper, shredded winter bamboo shoot, mushroom slice, white mushroom slice, asparagus, diced cowpea, diced snow pea, shredded black fungus, black sesame, peanut granule, cashew nut granule, shrimp skin, shrimp meat, shredded scallop, and shredded seaweed. The edible wolfberry leaf, the Longkou vermicelli, the spinach, the celery, the cordyceps flower, the diced carrot, the corn grain, the segmented shallot, the shredded green Chinese onion, the shredded color pepper, the shredded winter bamboo shoot, the mushroom slice, the white mushroom slice, the asparagus, the diced cowpea, the diced snow pea, the shredded black fungus, the black sesame, the peanut granule, the cashew nut granule, the shrimp skin, the shrimp meat, the shredded scallop, and the shredded seaweed are prepared in equal parts by mass.

In an embodiment, the tofu is an old tofu which is used in the dumpling filling after being baked to remove water.

In an embodiment, the seasoning includes oyster sauce, white pepper, sesame oil, edible oil, olive oil, grape seed oil, soy sauce, ginger powder, cooking wine and natural sea salt; the dipping sauce includes vinegar, garlic paste and chili oil.

In an embodiment, the dumpling dough includes the raw materials: 800 parts by mass of the flour and 400 parts by mass of the water; the dumpling filling includes the raw materials: 250 parts by mass of the main food material, 250 parts by mass of the auxiliary food material, 500 parts by mass of the additive food material, and the rest is the seasoning.

In an embodiment, the dumpling dough includes the raw materials: 850 parts by mass of the flour, and 430 parts by mass of the water; the dumpling filling includes the raw materials: 280 parts by mass of the main food material, 280 parts by mass of the auxiliary food material, 560 parts by mass of the additive food material, and the rest is the seasoning.

In an embodiment, the dumpling dough includes the raw materials: 900 parts by mass of the flour, and 450 parts by mass of the water; the dumpling filling includes the raw materials: 310 parts by mass of the main food material, 310 parts by mass of the auxiliary food material, 620 parts by mass of the additive food material, and the rest is the seasoning.

The beneficial effects of the embodiments of the invention are as follows: the recipe of the dumpling filling of the invention can make the consumer easily and conveniently eat more than thirty different kinds of food ingredients at one time in daily life, so that the consumer can achieve a healthy diet way of obtaining comprehensive nutrition. In the process of preparing the dumpling filling, the food ingredients in the dumpling filling of this recipe do not need to be cut too small, among which the shallot is cut into sections, each of which is nearly two centimeters in length, making the dumpling fillings chewy. A large amount of a variety of oils are used to prepare the dumpling filling, including sesame oil, corn oil, olive oil, grape seed oil, light soy sauce and oyster sauce are used to prepare the filling, which makes it easy to pack a variety of coarser food ingredients. The preparing method is simple, a variety of food ingredients are reasonably matched, the taste is good, the nutrition is balanced, and it is suitable for fast food to supplement comprehensive nutrition and is worthy of promotion.

### DETAILED DESCRIPTION OF EMBODIMENTS

The invention is further explained below in conjunction with concrete embodiments.

### Embodiment 1

The embodiment of the invention provides a preparing method of nutrition-balanced dumplings based on more than thirty kinds of food ingredients including a dumpling dough, a dumpling filling, a seasoning and a dipping sauce. The dumpling dough includes the following raw materials: 800 parts by mass of flour and 400 parts by pass of water. The dumpling filling includes the following raw materials: 250 parts by mass of a main food material, 250 parts by mass of an auxiliary food material and 500 parts by mass of an additive food material, and the rest is the seasoning. The preparing method includes the following steps:

S1, providing raw materials for the dumpling dough, the dumpling filling and the seasoning, preparing the dumpling dough, and proofing the prepared dumpling dough for 40-50 minutes;

S2, preparing the dumpling filling during proofing the prepared dumpling dough by cutting the main food material, the auxiliary food material and the additive food material to 0.5 mm in lengths, adding the seasoning and stirring;

S3, rolling the proofed dumpling dough for wrapping the dumpling filling to thereby obtain dumplings, putting the dumplings into a pot with cold water and heating for cooking the dumplings with a period of 7-8 minutes; and

S4, taking the dumplings out of the pot after the cooking for being eaten with the dipping sauce.

### Embodiment 2

The embodiment of the invention provides a preparing method of nutrition-balanced dumplings based on more than thirty kinds of food ingredients including a dumpling dough, a dumpling filling, a seasoning and a dipping sauce. The dumpling dough includes the following raw materials: 850 parts by mass of flour and 430 parts by pass of water. The dumpling filling includes the following raw materials: 280 parts by mass of a main food material, 280 parts by mass of an auxiliary food material and 560 parts by mass of an additive food material, and the rest is the seasoning. The preparing method includes the following steps:

S1, providing raw materials for the dumpling dough, the dumpling filling and the seasoning, preparing the dumpling dough, and proofing the prepared dumpling dough for 40-50 minutes;

S2, preparing the dumpling filling during proofing the prepared dumpling dough by cutting the main food material, the auxiliary food material and the additive food material to 0.5 mm in lengths, adding the seasoning and stirring;

S3, rolling the proofed dumpling dough for wrapping the dumpling filling to thereby obtain dumplings, putting the dumplings into a pot with cold water and heating for cooking the dumplings with a period of 7-8 minutes; and

S4, taking the dumplings out of the pot after the cooking for being eaten with the dipping sauce.

### Embodiment 3

The embodiment of the invention provides a preparing method of nutrition-balanced dumplings based on more than thirty kinds of food ingredients including a dumpling dough, a dumpling filling, a seasoning and a dipping sauce. The dumpling dough includes the following raw materials: 900 parts by mass of a flour and 450 parts by pass of a water. The dumpling filling includes the following raw materials: 310 parts by mass of a main food material, 310 parts by mass of an auxiliary food material and 620 parts by mass of an additive food material, and the rest is the seasoning. The preparing method includes the following steps:

S1, providing raw materials for the dumpling dough, the dumpling filling and the seasoning, preparing the dumpling dough, and proofing the prepared dumpling dough for 40-50 minutes;

S2, preparing the dumpling filling during proofing the prepared dumpling dough by cutting the main food material, the auxiliary food material and the additive food material to 0.5 mm in lengths, adding the seasoning and stirring;

S3, rolling the proofed dumpling dough for wrapping the dumpling filling to obtain dumplings, putting the dumplings into a pot with cold water and heating for cooking the dumplings with a period of 7-8 minutes; and

S4, taking the dumplings out of the pot after the cooking for being eaten with the dipping sauce.

In the above embodiments, a mass ratio of the flour and the water in the dumpling dough is about 2:1, a mass ratio of the main food material, the auxiliary material and the additive food material is 1:1:2. The main food material includes any one of Chinese cabbage, leek, pea sprout, and 9:1 refined meat. The auxiliary food material includes hen's egg, quail egg, tofu and yuba; and the hen's egg, the quail egg, the tofu and the yuba are prepared in equal parts by mass. The additive food material includes edible wolfberry leaf, Longkou vermicelli, spinach, celery, cordyceps flower, diced carrot, corn grain, segmented shallot, shredded green Chinese onion, shredded color pepper, shredded winter bamboo shoot, mushroom slice, white mushroom slice, asparagus, diced cowpea, diced snow pea, shredded black fungus, black sesame, peanut granule, cashew nut granule, shrimp skin, shrimp meat, shredded scallop, and shredded seaweed prepared in equal parts by mass. The tofu is an old tofu which is used in the dumpling filling after being baked to remove water. The seasoning includes oyster sauce, white pepper, sesame oil, edible oil, olive oil, grape seed oil, soy sauce, ginger powder, cooking wine and natural sea salt; the dipping sauce includes vinegar, garlic paste and chili oil.

The above-mentioned embodiments were prepared and implemented one by one, and the finished dumplings obtained were subjected to taste experiments and nutrient composition identifications. It was obtained that the nutrition ratio of the dumplings made in the above-mentioned embodiment 1 was the most uniform and the taste was the best.

The above are only preferred embodiments of the invention, and does not limit the patent protection scope of the invention. Any modification by replacing or changing the food ingredient(s) in the dumpling filling recipe of more than thirty kinds of food ingredients according to the technical solution of the invention and its inventive concept should be included in the scope of patent protection of the invention.

What is claimed is:

1. A preparing method of nutrition-balanced dumplings based on more than thirty kinds of food ingredients comprising a dumpling dough, a dumpling filling, a seasoning and a dipping sauce; wherein the dumpling dough comprises raw materials: 800-900 parts by mass of flour and 400-500 parts by mass of water; the dumpling filling comprises raw materials: 250-310 parts by mass of a main food material, 250-310 parts by mass of an auxiliary food material, and 500-620 parts by mass of an additive food material; the preparing method comprises following steps:
S1, providing raw materials for the dumpling dough, the dumpling filling and the seasoning, preparing the dumpling dough, and proofing the prepared dumpling dough for 40-50 minutes;
S2, preparing the dumpling filling during proofing the prepared dumpling dough by cutting the main food material, the auxiliary food material and the additive food material to 0.5 mm in lengths, adding the seasoning and stirring;
S3, rolling the proofed dumpling dough for wrapping the dumpling filling to thereby obtain dumplings, putting the dumplings into a pot with cold water and heating for cooking the dumplings with a period of 7-8 minutes; and
S4, taking the dumplings out of the pot after the cooking for being eaten with the dipping sauce.

2. The preparing method of nutrition-balanced dumplings based on more than thirty kinds of food ingredients as claimed in claim 1, wherein the flour and the water in the dumpling dough has a mass ratio of 2:1; and the main food material, the auxiliary food material and the additive food material in the dumpling filling has a mass ratio of 1:1:2.

3. The preparing method of nutrition-balanced dumplings based on more than thirty kinds of food ingredients as claimed in claim 1, wherein the main food material comprises any one of Chinese cabbage, leek, pea sprout, and 9:1 refined meat.

4. The preparing method of nutrition-balanced dumplings based on more than thirty kinds of food ingredients as claimed in claim 1, wherein the auxiliary food material comprises hen's egg, quail egg, tofu and yuba; and the hen's egg, the quail egg, the tofu and the yuba are prepared in equal parts by mass.

5. The preparing method of nutrition-balanced dumplings based on more than thirty kinds of food ingredients as claimed in claim 1, wherein the additive food material comprises edible wolfberry leaf, Longkou vermicelli, spinach, celery, cordyceps flower, diced carrot, corn grain, segmented shallot, shredded green Chinese onion, shredded color pepper, shredded winter bamboo shoot, mushroom slice, white mushroom slice, asparagus, diced cowpea, diced snow pea, shredded black fungus, black sesame, peanut granule, cashew nut granule, shrimp skin, shrimp meat, shredded scallop, and shredded seaweed;
the edible wolfberry leaf, the Longkou vermicelli, the spinach, the celery, the cordyceps flower, the diced carrot, the corn grain, the segmented shallot, the shredded green Chinese onion, the shredded color pepper, the shredded winter bamboo shoot, the mushroom slice, the white mushroom slice, the asparagus, the diced cowpea, the diced snow pea, the shredded black fungus, the black sesame, the peanut granule, the cashew nut granule, the shrimp skin, the shrimp meat, the shredded scallop, and the shredded seaweed are prepared in equal parts by mass.

6. The preparing method of nutrition-balanced dumplings based on more than thirty kinds of food ingredients as claimed in claim 4, wherein the tofu is an old tofu which is used in the dumpling filling after being baked to remove water.

7. The preparing method of nutrition-balanced dumplings based on more than thirty kinds of food ingredients as claimed in claim 1, wherein the seasoning comprises oyster sauce, white pepper, sesame oil, edible oil, olive oil, grape seed oil, soy sauce, ginger powder, cooking wine and natural sea salt; the dipping sauce comprises vinegar, garlic paste and chili oil.

8. The preparing method of nutrition-balanced dumplings based on more than thirty kinds of food ingredients as claimed in claim 1, wherein the dumpling dough comprises the raw materials: 800 parts by mass of the flour and 400 parts by mass of the water; the dumpling filling comprises the raw materials: 250 parts by mass of the main food material, 250 parts by mass of the auxiliary food material and 500 parts by mass of the additive food material, and the rest is the seasoning.

9. The preparing method of nutrition-balanced dumplings based on more than thirty kinds of food ingredients as claimed in claim 1, wherein the dumpling dough comprises the raw materials: 850 parts by mass of the flour, and 430 parts by mass of the water; the dumpling filling includes the raw materials: 280 parts by mass of the main food material, 280 parts by mass of the auxiliary food material and 560 parts by mass of the additive food material, and the rest is the seasoning.

10. The preparing method of nutrition-balanced dumplings based on more than thirty kinds of food ingredients as claimed in claim 1, wherein the dumpling dough comprises the raw materials: 900 parts by mass of the flour, and 450 parts by mass of the water; the dumpling filling comprises the raw materials: 310 parts by mass of the main food material, 310 parts by mass of the auxiliary food material and 620 parts by mass of the additive food material, and the rest is the seasoning.

11. The preparing method of nutrition-balanced dumplings based on more than thirty kinds of food ingredients as claimed in claim 1, wherein the dumpling filling comprises the main food material, the auxiliary food material and the additive food material; and a mass ratio of the main food material, the auxiliary food material and the additive food material is 1:1:2;
the additive food material comprises edible wolfberry leaf, Longkou vermicelli, spinach, celery, cordyceps flower, diced carrot, corn grain, segmented shallot, shredded green Chinese onion, shredded color pepper, shredded winter bamboo shoot, mushroom slice, white mushroom slice, asparagus, diced cowpea, diced snow pea, shredded black fungus, black sesame, peanut granule, cashew nut granule, shrimp skin, shrimp meat, shredded scallop, and shredded seaweed prepared in equal parts by mass.

12. The preparing method of nutrition-balanced dumplings based on more than thirty kinds of food ingredients as claimed in claim 11, wherein the main food material comprises any one of Chinese cabbage, leek, pea sprout, and 9:1 refined meat; the auxiliary food material comprises hen's egg, quail egg, tofu and yuba; and the hen's egg, the quail egg, the tofu and the yuba are prepared in equal parts by mass.
